(19) United States
(12) Patent Application Publication
(10) Pub. No.: US 2006/0106880 A1
(43) Pub. Date: May 18, 2006

(54) Managing free space in file systems

(76) Inventors: Jeffrey Wang, Shanghai (CN); Kiran K. Bangalore, Folsom, CA (US)

Correspondence Address: TROP PRUNER & HU, PC, 8554 KATY FREEWAY, SUITE 100, HOUSTON, TX, 77024, US

(21) Appl. No.: 10/991,594

(22) Filed: Nov. 18, 2004

(51) Int. Cl. G06F 17/30

(52) U.S. Cl. 707/200

(57) ABSTRACT

A header may be indicated for objects that have been deleted. As a result, the deleted objects, which may be called holes, may be manipulated in the same way as objects that contain real data. This enables the holes to be coalesced and reclaimed in one operation when necessary. In other words, when the available memory space is insufficient to write a new object, one or more holes may be reclaimed using their headers and the new object written into the space released by the reclamation process. As a result, the number of reclamations may be reduced in some cases, improving performance.

### BACKGROUND

This invention relates generally to file systems.

A flash file system is a file system stored on a flash memory. Flash file systems manage downloaded code objects such as Java applets and games. Flash file systems store code objects contiguously in a specific volume. In such case, there is no free or dirty space between valid objects. Herein free or dirty space will be referred to as a hole. Thus, the flash file system assures that all available space of the flash memory is merged into one chunk. Then, the largest possible new object can be written into the available flash memory space.

One problem that arises is that after deleting one object, a hole would be generated between valid objects. All objects after the hole are moved up to coalesce with the last valid object. This moving up may be called a reclamation. The reclamation results are achieved by rewriting the data to the new memory location. Thus, a specific volume may need to be rewritten in total.

This rewriting by a reclamation may happen multiple times to reclaim all of the space after the deleted object. For example, if the first object in the volume needs to be reclaimed, everything in the volume must be rewritten. Not only is this not efficient, but the time needed to do such movement of data may adversely affect the performance of the device. For example, the ability of the device including the flash file system to operate in a seamless fashion may be adversely affected. The user may realize that the system is unable to proceed during such reclamation.

Thus, there is a need for better ways to deal with holes in file systems.

### BRIEF DESCRIPTION OF THE DRAWINGS

FIG. 1 is a schematic depiction of one embodiment of the present invention in a system;

FIGS. 2A-2E are schematic depictions of a file system in the course of deleting two objects and creating another object; and

FIG. 3 is a flow chart for software useful in the embodiment shown in FIG. 1 in accordance with one embodiment of the present invention.

### DETAILED DESCRIPTION

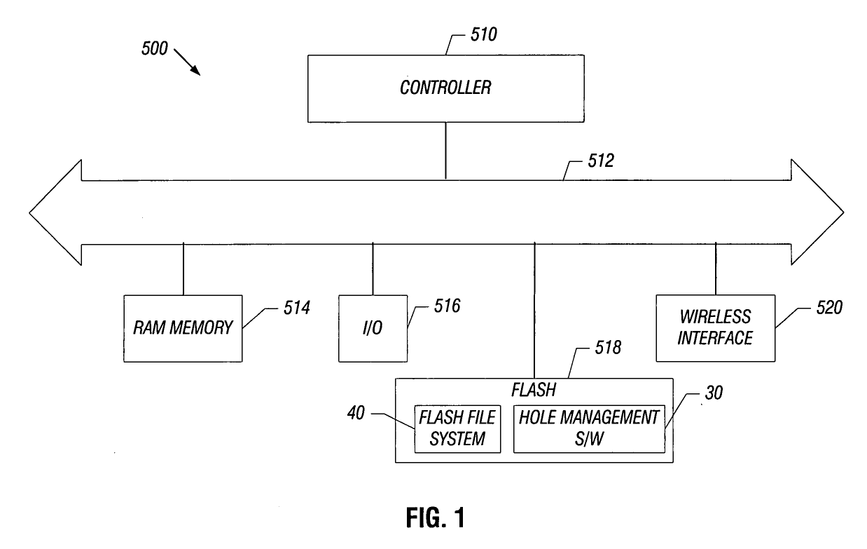

Referring to FIG. 1, a processor-based system 500 may be any processor-based system including a mobile or battery powered processor-based system. In some embodiments, the system 500 includes a controller 510 which may, for example, include a general purpose microprocessor or a digital signal processor, as two examples. The controller 510 may be coupled by a bus 512 to any number of components, including a random access memory 514. The bus 512 may also be coupled to an input/output (I/O) 516. Typical input/output devices may include a display, a keyboard, a mouse, serial ports, or parallel ports, to mention a few examples. In some embodiments, a wireless interface 520 may be coupled to the bus 512. The wireless interface 520 may be a radio frequency transceiver, in some embodiments, that includes, for example, an antenna such as a dipole antenna. The wireless interface 520 may be in accordance with any wireless protocol, including short range and long range radio frequency communication protocols and cellular telephone protocols.

A flash memory 518 may also be coupled to the bus 512. The flash memory 518 may include a flash file system 40 and hole management software 30 for managing holes on the file system 40.

The system 500 may be any of a variety of processor-based systems including a personal digital assistant, a cellular telephone, a camera, a camcorder, a game console, a media center, a media player, a laptop computer, and a tablet, to mention a few examples. It may also be a non-mobile computer in some embodiments of the present invention.

In accordance with some embodiments of the present invention, multiple holes may exist between valid code objects in a specific volume. After one object in the volume is deleted, the hole may be left at the original location of the deleted object without being immediately reclaimed. When writing a new object, the volume is scanned to find an appropriate free chunk of memory space within the volume of sufficient size to accommodate the new object. Generally, the suitable free chunk is the first available space with the closest size to that actually needed to store the new object.

If there is no such hole suitably sized to receive the new object, then a defragmentation is performed. The defragmentation coalesces the existing valid objects, reclaims the holes, and merges the available space until an available space of the desired size to accommodate the new object is created.

In many situations, this approach may involve fewer space reclaims than the conventional hole management methods. In this way, multiple holes may be reclaimed at one time and multiple free chunks may be merged during one defragmentation. As a result, in some embodiments, significant improvement in object deletion performance and space defragmentation performance may be achieved.

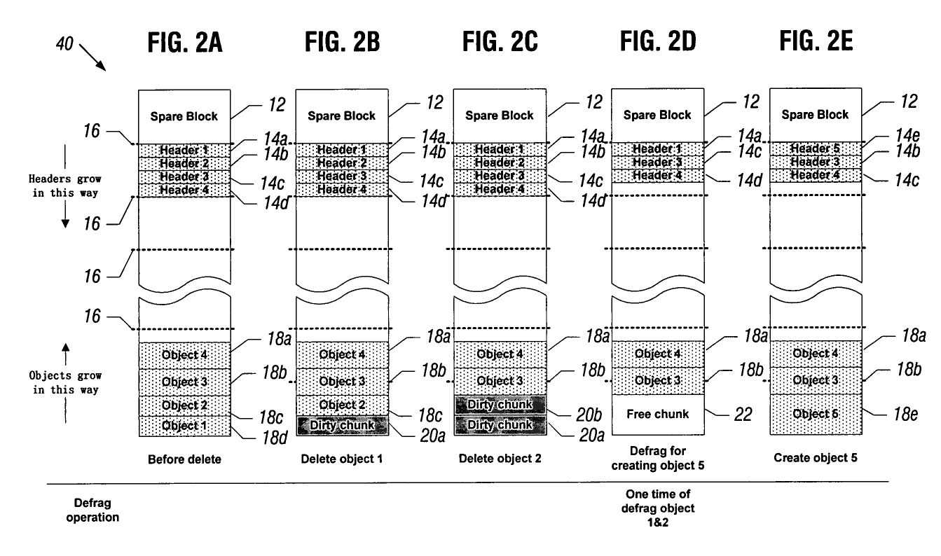

The hole management software 30 may be stored on the flash memory 518 with the flash file system 40 in one embodiment. As shown in FIG. 2A, the flash file system 40, before any objects are deleted, may include a spare block 12, separated by a block boundary 16 from a block including a plurality of headers 14a-14d. A header 14a-14d is associated with each of the objects 18a-18d stored in another block across one or more block boundaries 16. While only four headers and four objects are illustrated in FIG. 2A, those skilled in the art will appreciate that a great number of headers and a great number of objects may be stored within the flash file system 40.

As indicated on the left in FIG. 2A, as additional objects are added to the flash file system 40, the system 40 grows upwardly, while the headers grow downwardly. That is, headers are added on the bottom of the stack and objects are added on the top of the stack.

Then, referring to FIG. 2B, the object 18d may be deleted. As a result, a dirty chunk or hole 20a is left. The other objects 18 and their headers 14 remain for the time being as they are. However, the header 14a identifies the hole 20a, as modified in a fashion to be described hereinafter.

Normally, each valid code object 14 has one object header 18 that stores all characteristics of the object, including, for example, the object name, type, size, identifier, and the like. To help manage multiple holes between valid objects (even though there is no actual data for the hole) an object header is still associated with each hole, indicating the hole's size and attributes (free or dirty). As a result, holes, such as hole 20a, are treated and manipulated as a normal object. Thus, normal object operations can be applied to holes and, as a result, holes may be more easily managed in some embodiments. Thus, in the case of FIG. 2B, the header 14a is adapted to act as the header for the hole or dirty chunk 20a.

Then, referring to FIG. 2C, the object 18c is deleted, creating a second dirty chunk 20b in its place. Again, the associated header 14b is appropriately adapted to indicate that the corresponding object is, in fact, a hole and has certain characteristics.

Then, as shown in FIG. 2D, at some point in time, the available memory space is no longer sufficient for an object to be written. As a result, a defragmentation creates a free chunk 22 of memory space which is available to be written to. Thus, the headers 14c and 14d, for the objects 18b and 18a, remain unchanged, but the header 14a now indicates that its associated object is a free chunk 22.

It should be noted that the defragmentation of the dirty chunks 20a and 20b can happen all at one time. Of course, while an illustration is given wherein two dirty chunks or holes 20 are reclaimed at the same time, more or less holes may be reclaimed as needed to achieve an appropriate available space to write the new object.

In the course of defragmentation, holes are reclaimed and coalesced at one time. In some embodiments, this enables more flexible manipulation of any given object. By rewriting and reorganizing the headers, it is easy to write a new object into a hole, to reclaim one dirty chunk to a free chunk, to truncate an object's size, and to expand an object's size.

Then, as shown in FIG. 2E, a new object 18e can be written into the free chunk 22. A header 14e is established to identify the newly written object 18e.

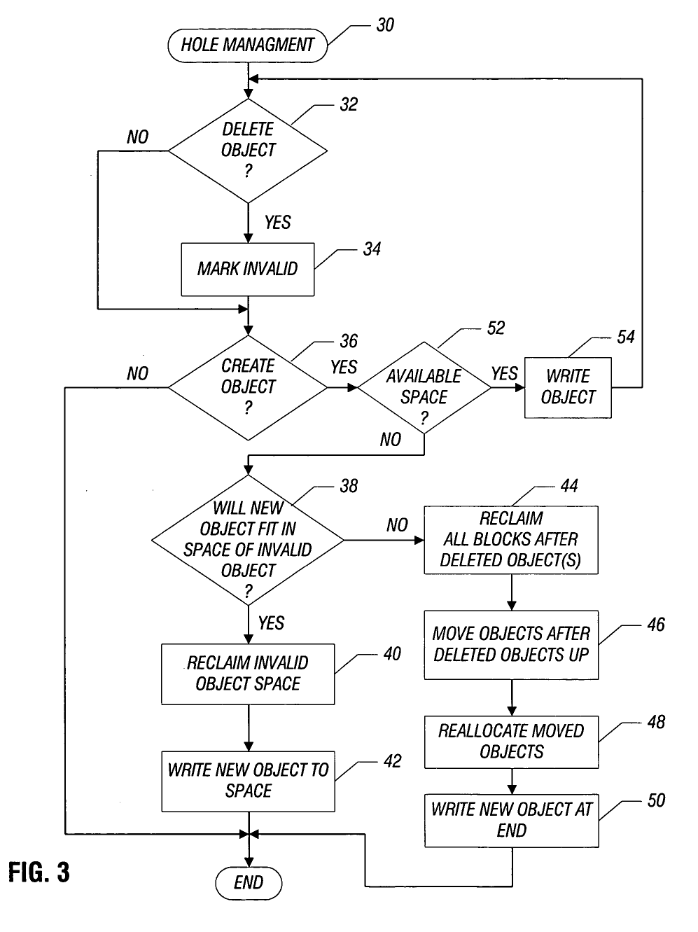

Referring to FIG. 3, a flow chart illustrates the hole management software 30. Initially, a check at diamond 32 determines whether an object is scheduled to be deleted. If so, the header for that object is marked as invalid. In other words, the header is modified to indicate that the corresponding object is now a hole or a dirty chunk, as indicated in block 34. However, a corresponding header for the deleted object or hole is maintained so that that hole can be manipulated like any other object.

To create an object, a check at diamond 36 determines that a new object must be stored. If so, a check determines whether there is an available memory space for the object. If so, the object is simply stored in that available space. If not, a check at diamond 38 determines whether the new object will fit in the space of a hole or so-called invalid object. If so, the invalid object space may be reclaimed as indicated in block 40. This reclamation may reclaim that number of holes which are needed to receive the new object. Then, the new object is written to the space as indicated in block 42. At the same time, the headers for the reclaimed space may be coalesced to create a new header.

If the object will not fit into the space of one single invalid object as determined at diamond 38, all of the blocks after any deleted object or objects may be reclaimed as indicated in block 44. The objects after the deleted object or objects may be moved up, as indicated in block 46, and all of the moved objects may be reallocated as indicated in block 48. Finally, the new objects may be written at the end as indicated in block 50.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
associating a header with a deleted object.

2. The method of claim 1 including indicating in said header that the associated object has been deleted.

3. The method of claim 2 including indicating in said header the size of the space left by the deleted object.

4. The method of claim 3 including reclaiming the deleted object only when the space occupied by the deleted object is needed to store a new object.

5. The method of claim 1 including manipulating the deleted object using the header.

6. The method of claim 1 including adding headers to a file system in one direction and adding objects to the file system in the opposite direction.

7. The method of claim 1 including defragmenting the file system only when the available space is insufficient to accommodate an object that needs to be written.

8. The method of claim 7 including defragmenting the space of two deleted objects at the same time.

9. The method of claim 1 including storing a new object in the space occupied by the deleted object, and associating a header with the newly stored object.

10. The method of claim 1 including organizing a file system for a flash memory having headers for deleted objects.

11. The method of claim 1 including maintaining headers for each object in the file system and for a deleted object.

12. An article comprising a medium storing instructions that, if executed, enable a processor-based system to associate a header with a deleted object.

13. The article of claim 12 further storing instructions that, if executed, enable the processor-based system to indicate in the header that the associated object has been deleted.

14. The article of claim 13 further storing instructions that, if executed, enable the processor-based system to indicate in the header the size of the space left by the deleted object.

15. The article of claim 14 further storing instructions that, if executed, enable the processor-based system to reclaim the deleted object only when the space occupied by the deleted object is needed to store a new object.

16. The article of claim 12 further storing instructions that, if executed, enable the processor-based system to manipulate the deleted object using the header.

17. The article of claim 12 further storing instructions that, if executed, enable the processor-based system to defragment the file system only when the available space is insufficient to accommodate an object that needs to be written.

18. The article of claim 17 further storing instructions that, if executed, enable the processor-based system to defragment the space of two deleted objects at the same time.

19. The article of claim 12 further storing instructions that, if executed, enable the processor-based system to store a new object in the space occupied by the deleted object, and associate a header with the newly stored object.

20. The article of claim 12 further storing instructions that, if executed, enable the processor-based system to maintain headers for each object in a file system and for a deleted object.

21. A flash memory comprising:
a first flash memory portion storing a flash file system; and
a second flash memory portion storing software to associate a header with a deleted file system object.

22. The memory of claim 21 wherein said memory stores instructions to indicate in the header that the associated object has been deleted.

23. The memory of claim 21 wherein said memory stores instructions to indicate in the header the size of the space left by the deleted object.

24. The memory of claim 21 storing instructions to reclaim the deleted object only when the space occupied by the deleted object is needed to store a new object.

25. A system comprising:
a controller;
a wireless interface coupled to said controller; and
a flash memory coupled to said controller, said flash memory including a file system and code to associate a header with a deleted object.

26. The system of claim 25 wherein said flash memory includes code to indicate in the header that the associated object has been deleted.

27. The system of claim 25 including code to indicate in the header the size of the space left by the deleted object.

28. The system of claim 25 including code to reclaim the deleted object only when the space occupied by the deleted object is needed to store a new object.

29. The system of claim 25 including code to defragment the file system only when the available space is insufficient to accommodate an object that needs to be written.

30. The system of claim 25 including code to store a new object in the space of a deleted object.
